(19) United States
(12) Patent Application Publication
(10) Pub. No.: US 2018/0370358 A1
(43) Pub. Date: Dec. 27, 2018

(54) VEHICLE SPEED REGULATION APPARATUS AND SYSTEM

(71) Applicant: Benjamin Miller, Sidel, IL (US)

(72) Inventor: Benjamin Miller, Sidel, IL (US)

(21) Appl. No.: 16/014,728

(22) Filed: Jun. 21, 2018

Related U.S. Application Data
(60) Provisional application No. 62/522,894, filed on Jun. 21, 2017.

(51) Int. Cl. B60K 31/00; G08G 1/052; B60W 30/14

(52) U.S. Cl. CPC B60K 31/0058; B60K 2031/0091; B60W 30/146; G08G 1/052

(57) ABSTRACT

A vehicle speed regulation apparatus and system comprises a speed control apparatus having a front panel with a solar panel and display screen, a control panel with means to increase or decrease a desired speed, an internal communication transceiver, and a means for communicating with a vehicle transceiver, along with other elements.

### CROSS-REFERENCE TO RELATED APPLICATION

This application claims priority to U.S. Provisional Application No. 62/522,894 filed on Jun. 21, 2017, the disclosure of which, including any materials incorporated by reference therein, is incorporated herein by reference in its entirety.

### TECHNICAL FIELD

The present invention relates generally to vehicles. More particularly, the present invention concerns an apparatus and system for regulating the speed of a vehicle in designated areas.

### BACKGROUND

Speed limits are enacted for the safety of other drivers on the road, as well as pedestrians in the area. As the world population increases, so do the number of vehicles on the road and the number of potential accidents. Currently, there are far too many traffic accidents that occur in school zones, construction zones, and other areas where reduced speeds are posted. Drivers tend to ignore these signs, unless a police car is present or unless there are traffic cameras. Although police officers usually patrol areas with reduced speeds and issue traffic tickets as a deterrent, doing so is an expense on municipality resources and tax dollars. Often times, monitoring the speed of drivers in school zones is often left to school district employees or is left up to the honor system. No active system exists yet, despite significant improvements in the art, to automatically regulate the speed of a vehicles entering and exiting a school zone, construction zone, or any other designated area where there are reduced speeds and walking pedestrians or workers. The problem is how to wirelessly and automatically regulate the speed of a vehicle in a designated area.

Thus, various attempts have been made to solve the problems which may be found in the related art but have been unsuccessful. A need exists for a new automatic apparatus and system for decelerating a vehicle's speed when it enters a speed zone entrance and accelerating the vehicle's speed when it exits the speed zone without any need to pre-select speeds to control such a speed regulation system to avoid the challenges and problems with the prior art.

### SUMMARY OF THE INVENTION

It is to be understood that in the present disclosure, all embodiments are provided as illustrative and non-limiting representatives of many possible embodiments. In addition, the terms “is,” “can,” “will,” and the like are herein used as synonyms for and interchangeable with terms such as “may,” “may provide for,” and “it is contemplated that the present invention may” and so forth.

Furthermore, all elements listed by name, such as a pool wall, floor, steps, etc., are herein meant to include or encompass all equivalents for such elements. For example, in addition to a “pool”, any water-containing item big enough to house a living organism capable of drowning is also contemplated by the present invention. Moreover, while the invention will be described in connection with above-ground pools it is understood that the invention is not limited in scope to use with pools but may be used with other types of water activities reasonably likely to benefit from active safety monitoring. Such equivalents are contemplated for each element named in its particular herein.

For purposes of summarizing, certain aspects, advantages, and novel features of the present invention are provided herein. It is to be understood that not all such aspects, advantages, or novel features may be provided in any one particular embodiment. Thus, the disclosed subject matter may be embodied or carried out in a manner that achieves or optimizes one aspect, advantage, or novel feature or group of features without achieving all aspects, advantages, or novel features as may be taught or suggested.

In view of the foregoing disadvantages inherent in the known art, the present invention relates to a pool having an adjustable floor that overcomes the deficiencies of the prior art. The general purpose of the present invention, which shall be described subsequently in greater detail, is to provide a means for automatically decelerating and accelerating a vehicle as it enters and exits a designated reduced speed zone.

The features of the invention which are believed to be novel are particularly pointed out and distinctly claimed in the concluding portion of the specification. By way of non-limiting example, the present invention provides a novel solution for preventing drowning. These and other features, aspects, and advantages of the present invention will become better understood with reference to the following drawings and detailed description.

The present invention provides for an apparatus and system to automatically reduce the speed of a vehicle that enters a reduced speed zone, and automatically accelerating the speed of the vehicle upon exiting the reduced speed zone. The vehicle speed reducing system comprises of two stand-alone transmitters, a receiver, and a vehicle speed regulating governor. The activating transmitter, placed at the beginning of a reduced speed zone that sends a wireless signal to a receiver located within a vehicle. When the signal is received, the vehicle's attached governor is activated and the vehicle will automatically be reduced. When the vehicle passes the deactivating transmitter located at the end of the reduced speed zone, the deactivating transmitter sends a wireless signal to the vehicle's receiver. The vehicle's governor is then deactivated and the driver of the vehicle is able to accelerate the vehicle's speed at will.

In a preferred embodiment of the present invention, the vehicle regulation speed system transmitters are solar powered, utilizing energy captured by the solar panel located on the front of the transmitter or on a flat outward facing surface of the transmitter. The transmitter also comprises a control panel to preset the speed limit which is transmitted to the vehicle's receiver. The control panel allows a user to increase or decrease the selected speed and may be accessed remotely or locked to prevent unauthorized use or tampering.

The present invention may provide the following benefits for consumers everywhere: an automatic and efficient system for slowing down vehicles to safe speeds when passing through designated areas; will save the lives of highway construction workers, school children, and other pedestrians in designated areas; will reduce the amount of time law enforcement officers have to spend patrolling school zones, construction zones or other areas where reduced speeds are posted.

The embodiments of the invention described herein are exemplary and numerous modifications, variations and rearrangements can be readily envisioned to achieve substantially equivalent results, all of which are intended to be embraced within the spirit and scope of the invention. Furthermore, while the preferred embodiment of the invention has been described in terms of the components and configurations, it is understood to that the invention is not intended to be limited to those specific dimensions or configurations but is to be accorded the full breadth and scope of the spirit of the invention.

### BRIEF DESCRIPTION OF THE DRAWINGS

These and other features, aspects and advantages of the present invention will become better understood with regard to the following description, appended claims, and accompanying figures where:

FIG. 1 shows a front perspective view of a speed control apparatus.

FIG. 2 shows a side view of an embodiment of a speed control apparatus in accordance with an embodiment of the invention.

FIG. 3 shows a close up perspective view of a vehicle speed regulation apparatus and system in a preferred use.

FIG. 4 shows a perspective view of a vehicle speed regulation apparatus and system in use.

### DETAILED DESCRIPTION

The present invention overcomes the limitations of the prior art by providing a new and more effective vehicle speed regulation apparatus and system.

All dimensions specified in this disclosure are by way of example only and are not intended to be limiting. Further, the proportions shown in these Figures are not necessarily to scale. As will be understood by those with skill in the art with reference to this disclosure, the actual dimensions and proportions of any embodiment or element of an embodiment disclosed in this disclosure will be determined by its intended use.

It is to be understood that the drawings and the associated descriptions are provided to illustrate potential embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

Throughout the drawings, reference numbers are re-used to indicate correspondence between referenced elements. In addition, the first digit of each reference number indicates the figure where the element first appears.

As used in this disclosure, except where the context requires otherwise, the term “comprise” and variations of the term, such as “comprising,” “comprises” and “comprised” are not intended to exclude other additives, components, integers or steps.

In the following description, specific details are given to provide a thorough understanding of the embodiments. However, it will be understood by one of ordinary skill in the art that the embodiments may be practiced without these specific details. Well-known features, elements or techniques may not be shown in detail in order not to obscure the embodiments.

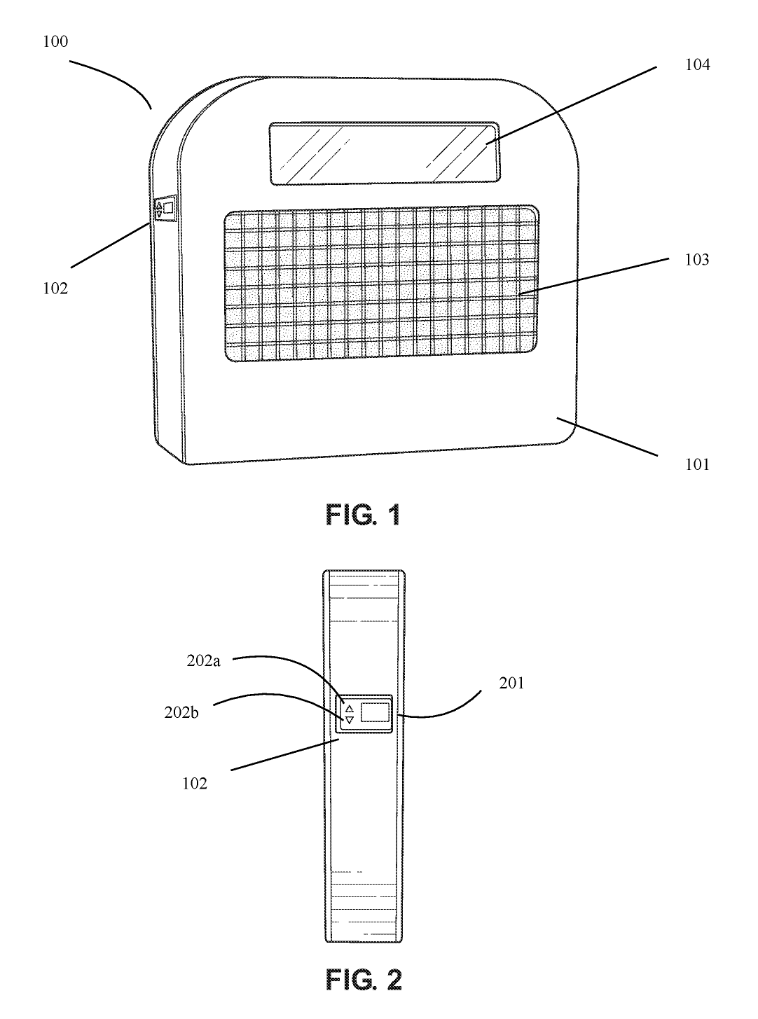

Turning attention to FIG. 1, a front perspective view of a speed control apparatus is shown. In the embodiment depicted, a viewer may perceive a speed control apparatus 100, having a front panel 101, a control panel 102, a solar panel 103, and a display screen 104.

In the embodiment disclosed in FIG. 1, the speed control apparatus 100, is powered by utilizing energy captured by the solar panel 103 located on the front panel 101 of the speed control apparatus 100, or other outward facing surface of the vehicle regulation apparatus 100. A viewer will note that a solar panel 103 located on the front panel 101 provides maximum sun exposure to ensure that the vehicle regulation apparatus 100 is properly and adequately powered.

The speed control apparatus 100, may in some embodiments, also provide for a display screen 104 to be positioned in the center most position of the front panel 101 (not pictured) wherein the display screen 104 has touch screen capabilities. The speed control apparatus 100 also has an internal transmitter (not shown) that has the capacity to send a signal to a vehicle's receiver (not shown) which communicates with a vehicle's governor (not shown). In the embodiment shown in FIG. 1, the speed control apparatus 100 is shown in a generally square or rectangular shape, but may of any shape known in the art, such as but not limited to a cylinder, a cube, a cuboid, a triangle, and so forth. Such shapes are also contemplated for any speed control apparatus disclosed herein.

With respect to FIG. 2, a side view of an embodiment of a speed control apparatus in accordance with an embodiment of the invention is shown. In the embodiment depicted, the control panel 102 has a viewable display screen 201 where the controller can view the desired speed of vehicles entering the reduced speed zone. The desired speed may be viewable on the control panel 102 A viewer will note that the control panel 201 has a means to increase the desired speed 202a and a means to decrease the desired speed 202b of a vehicle entering the reduced speed zone. In some embodiments, the speed control apparatus 100 may have features (not shown) to lock the control panel 102 and prevent the unauthorized access to the increase or decrease the desired speed.

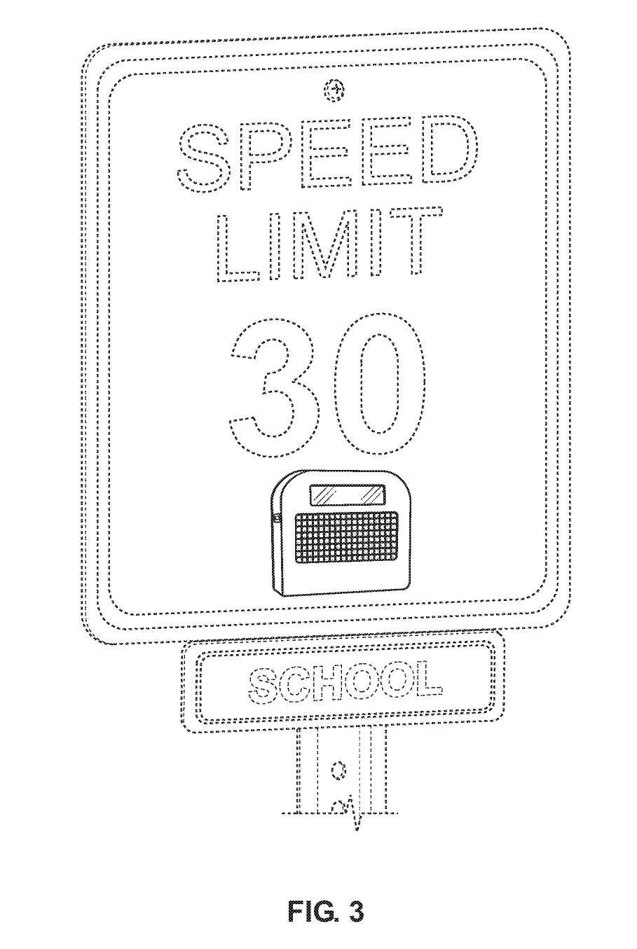

With regards to FIG. 3, a close up perspective view of a vehicle speed regulation apparatus and system in a preferred use. In the embodiment depicted, a viewer may perceive the speed control apparatus 100, attached or secured to a posted speed limit sign. The vehicle speed regulation apparatus and system requires one or more speed control apparatuses to be placed at the beginning of a reduced speed zone as well as at the end of a reduced speed zone.

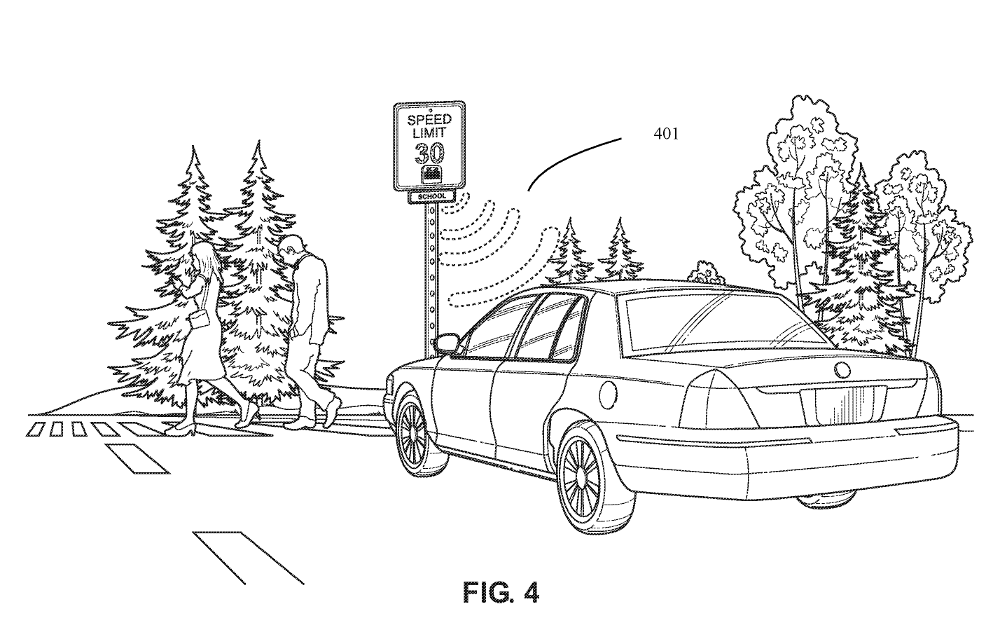

Turning attention to FIG. 4, a perspective view of a vehicle speed regulation apparatus and system in use is shown. In the embodiment depicted, a viewer may perceive the speed control apparatus 100, attached or secured to a posted speed limit sign, as well as communication waves 401 directed towards a vehicle driving into a reduced speed zone.

In the embodiment shown in FIG. 4, the speed control apparatus 100 transmits a signal 401 through the speed control apparatus's 100 internal transmitter (not shown) via a wireless signal such as Bluetooth or other wireless communication means. The speed control apparatus's 100 internal transmitter (not shown) transmits a signal that is received by the receiver of the vehicle (not shown) that is entering into the reduced speed zone. Once received, the vehicle's receiver (not shown) communicates with a speed governor (not shown) installed in the vehicle. The governor is activated and reduces the speed of the vehicle to the desired speed set on the speed control apparatus's 100 control panel 102.

### Conclusions, Ramifications, and Scope

Although the present invention has been described with a degree of particularity, it is understood that the present disclosure has been made by way of example and that other versions are possible. As various changes could be made in the above description without departing from the scope of the invention, it is intended that all matter contained in the above description or shown in the accompanying drawings shall be illustrative and not used in a limiting sense. The spirit and scope of the appended claims should not be limited to the description of the preferred versions contained in this disclosure.

All features disclosed in the specification, including the claims, abstracts, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means” for performing a specified function or “step” for performing a specified function should not be interpreted as a “means” or “step” clause as specified in 35 U.S.C. § 112.

While the present invention generally described herein has been disclosed in connection with a number of embodiments shown and described in detail, various modifications should be readily apparent to those of skill in the art.

What is claimed is:

1. A vehicle speed regulation apparatus and system, comprising:
at least two speed control apparatuses having a front panel, a solar panel, a display screen, and a control panel;
an internal control and communication mechanism powered by renewable energy;
means for increasing or decreasing a desired speed for a designated area;
means of detecting when a vehicle is within range of the speed control apparatus in a designated area;
a communication transmitter for sending information to a vehicle's transceiver on a speed limit in a specific area and a means responsive to said information to limit the flow of fuel to a vehicle's engine to the pre-selected speed for the designated area thereby reducing the speed of the vehicle to the pre-selected speed;
means for detecting when a vehicle is leaving a designated area;
means for sending information to a vehicle's transceiver on a speed limit upon leaving a designated area and a means responsive to said information to increase the flow of fuel to a vehicle's engine thereby allowing the user of the vehicle to control the speed of the vehicle at will.
